(19) United States
(12) Patent Application Publication
(10) Pub. No.: US 2023/0242128 A1
(43) Pub. Date: Aug. 3, 2023

(54) DRIVING FORCE ACCELERATION CALCULATION METHOD AND DEVICE THEREOF

(71) Applicant: BONDI TECHNOLOGY LIMITED, New Taipei City (TW)

(72) Inventors: Kam Kwong Allen WONG, New Taipei City (TW); Ho Lun WONG, New Taipei City (TW)

(73) Assignee: BONDI TECHNOLOGY LIMITED, New Taipei City (TW)

(21) Appl. No.: 17/587,559

(22) Filed: Jan. 28, 2022

(51) Int. Cl. B60W 40/107; B60W 30/18

(52) U.S. Cl. CPC B60W 40/107; B60W 30/18109; B60W 2510/104

(57) ABSTRACT

A driving force acceleration calculation method is executed by a processing module; the driving force acceleration calculation method includes receiving a tilt sensing signal from the tilt sensing unit, a sensed angle and a sensed acceleration from the gravity sensing unit; determining whether the tilt sensing signal is an uphill signal or a downhill signal; when determining that the tilt sensing signal is the uphill signal, calculating a driving force acceleration as the sensed acceleration plus the gravitational acceleration component; when determining that the tilt sensing signal is the downhill signal, calculating the driving force acceleration as the sensed acceleration minus the gravitational acceleration component; outputting the driving force acceleration; the method is able to more accurately calculate the driving force acceleration of a bike, therefore better knowing whether the bike suddenly decelerates.

### BACKGROUND OF THE INVENTION

### 1. Field of the Invention

The present invention relates to an acceleration calculation method and a device thereof, more particularly a driving force acceleration calculation method and a device thereof.

### 2. Description of the Related Art

According to Newton's second law of motion:

F=m×A;

a person with basic physics knowledge would understand that F stands for force, m stands for mass, and A stands for acceleration. When a mass of an object is constant, a force exerted on the object is linearly proportional to an acceleration of the object.

With reference to FIG. 9, when a bicycle 100A travels uphill along a direction “Z”, the bicycle 100A simultaneously endures a driving force F_{Z} pushing the bicycle 100A uphill and a gravitational force F_{G} dragging the bicycle 100A down. In FIG. 9, if a gravity sensing unit 20A is to be mounted on the bicycle 100A, an angle θ between a perpendicular direction from the bicycle 100A to the ground and a direction of gravity pulling the bicycle 100A would be known through the gravity sensing unit 20A. In other words, the angle θ is a sensed angle from the gravity sensing unit 20A. In FIG. 9, “V” represents the direction of gravity pulling the bicycle 100A, “H” represents a normal direction from the direction of gravity, and “X” represents a normal direction to a surface of the ground. In this example, direction “X” is also normal to the direction “Z”. The gravity sensing unit 20A is an accelerometer. The accelerometer is also known as a G sensor.

The gravitational force F_{G} exerted on the bicycle 100A can split into different components due to the angle θ. A net force F_{NET UP} exerted on the bicycle 100A can be viewed as:

F_{NET UP}=F_{Z}−F_{G}*sin(θ)

wherein the net force F_{NET UP} can be further expanded as:

m*A_{Z NET UP}=m*A_{Z}−m*g*sin(θ)

wherein m represents mass of the bicycle 100A, A_{Z NET UP} represents a net acceleration of the bicycle 100A going uphill, A_{Z} represents an acceleration of the driving force F_{Z}, in other words, a driving force acceleration for the bicycle 100A, and g represents the gravitational acceleration.

Once having the mass m of the bicycle 100A cancelled out, the above formula can be written as:

A_{Z NET UP}=A_{Z}−g*sin(θ)

wherein this formula represents how accelerations of the bicycle 100A going uphill can be calculated. Although A_{Z NET UP} represents a sensed acceleration from the gravity sensing unit 20A, A_{Z} represents an actual acceleration of the bicycle 100A without being affected by the gravitational acceleration.

With reference to FIG. 10, with similar logic, when the bicycle 100A travels downhill, the gravitational acceleration adds to an overall net acceleration of the bicycle 100A traveling downhill. When the bicycle 100A travels downhill, a net force F_{NET DOWN} exerted on the bicycle 100A can be written as:

F_{NET DOWN}=m*A_{Z NET DOWN}=F_{Z}+F_{G}*sin(θ)

wherein A_{Z NET DOWN} represents a net acceleration of the bicycle 100A going downhill. Once the above formula is simplified, the above formula can be written as:

A_{Z NET DOWN}=A_{Z}+g*sin(θ)

wherein this formula represents how accelerations of the bicycle 100A going downhill can be calculated.

In conclusion, when the bicycle 100A travels uphill and downhill, the sensed acceleration can be respectively represented into two different physics formulas as A_{Z NET UP} and A_{Z NET DOWN} This sensed acceleration in principle should be different from the driving force acceleration A_{Z} of the bicycle 100A. Only when the angle θ=0, in other words, only when the bicycle 100A is traveling on a flat surface will the driving force acceleration A_{Z} and the sensed accelerations A_{Z NET UP} and A_{Z NET DOWN} all equal each other.

However, currently when calculating the driving force acceleration A_{Z}, most of the bicycles 100A choose to ignore the effects of gravitational acceleration on the sensed accelerations A_{Z NET UP} and A_{Z NET DOWN} In other words, most of the bicycles 100A choose to view g*sin(θ) as zero to simplify calculations for the driving force acceleration A_{Z}.

More particularly, most of the bicycles 100A only come with the gravity sensing unit 20A, and the gravity sensing unit 20A is unable to sense whether the bicycle 100A is traveling uphill or downhill. The gravity sensing unit 20A is only able to provide the angle θ, and yet having the angle θ is still insufficient to determine whether the bicycle 100A creates the angle θ while traveling uphill or downhill. Without knowing the bicycle 100A traveling uphill or downhill, most of the bicycles 100A choose to view the sensed acceleration equal to the driving force acceleration A_{Z}, as a way of finding a middle ground for compensation. However this simplification sacrifices correctness of the aforementioned physics formulation, and therefore also loses the opportunity to more accurately calculate the driving force acceleration A_{Z} of the bicycle 100A.

### SUMMARY OF THE INVENTION

The present invention provides a method of calculating the driving force acceleration and a device thereof. The driving force acceleration calculation method of the present invention is executed by a processing module, and the processing module is electrically connected to a gravity sensing unit and a tilt sensing unit.

The driving force acceleration calculation method of the present invention includes the following steps: receiving a tilt sensing signal from the tilt sensing unit, a sensed angle and a sensed acceleration from the gravity sensing unit; calculating a gravitational acceleration component according to the sensed angle; determining whether the tilt sensing signal is an uphill signal or a downhill signal; when determining that the tilt sensing signal is the uphill signal, calculating a driving force acceleration as the sensed acceleration plus the gravitational acceleration component; when determining that the tilt sensing signal is the downhill signal, calculating the driving force acceleration as the sensed acceleration minus the gravitational acceleration component; and outputting the driving force acceleration.

A driving force acceleration calculation device of the present invention includes a gravity sensing unit, a tilt sensing unit, and a processing module. The gravity sensing unit generates a sensed angle by sensing a direction of gravitational pull, and generates a sensed acceleration by sensing speed changes. The tilt sensing unit generates a tilt sensing signal by sensing tilt. The processing module electrically connects the gravity sensing unit and the tilt sensing unit, receives the tilt sensing signal from the tilt sensing unit, the sensed angle and the sensed acceleration from the gravity sensing unit, and calculates a gravitational acceleration component according to the sensed angle.

The processing module determines whether the tilt sensing signal is an uphill signal or a downhill signal; when the processing module determines the tilt sensing signal is the uphill signal, the processing module calculates a driving force acceleration as the sensed acceleration plus the gravitational acceleration component; when the processing module determines the tilt sensing signal is the downhill signal, the processing signal calculates the driving force acceleration as the sensed acceleration minus the gravitational acceleration component; the processing module further outputs the driving force acceleration.

The present invention determines whether the tilt sensing signal is the uphill signal or the downhill signal to decide how the driving force acceleration should be calculated. In comparison with prior arts, the present invention calculates the driving force acceleration closer to the correct physics formulations mentioned in the prior art section. As a result, rather than simplifying physics formulations, the present invention is able to more accurately calculate the driving force acceleration. Once the driving force acceleration is accurately calculated, the present invention outputs the driving force acceleration to benefit a vehicle for further applications. Once having the accurately calculated driving force acceleration, the vehicle is able to better conduct further calculations relating to the vehicle for further applications, and thus benefiting many more aspects relating to how the vehicle operates.

### BRIEF DESCRIPTION OF THE DRAWINGS

FIG. 1 is a block diagram of a driving force acceleration calculation device of the present invention.

FIG. 2 is a flow chart of a driving force acceleration calculation method of the present invention.

FIG. 3 is another block diagram of the driving force acceleration calculation device of the present invention.

FIG. 4 is another flow chart of the driving force acceleration calculation method of the present invention.

FIG. 5 is another flow chart of the driving force acceleration calculation method of the present invention.

FIG. 6 is a perspective view of a sampling time and a sampling window time of the driving force acceleration calculation method of the present invention.

FIG. 7 is a perspective view of a driving force acceleration of the driving force acceleration calculation method of the present invention.

FIG. 8 is a perspective view of a delay time of the driving force acceleration calculation method of the present invention.

FIG. 9 is a perspective view of a bike traveling uphill.

FIG. 10 is a perspective view of the bike traveling downhill.

### DETAILED DESCRIPTION OF THE INVENTION

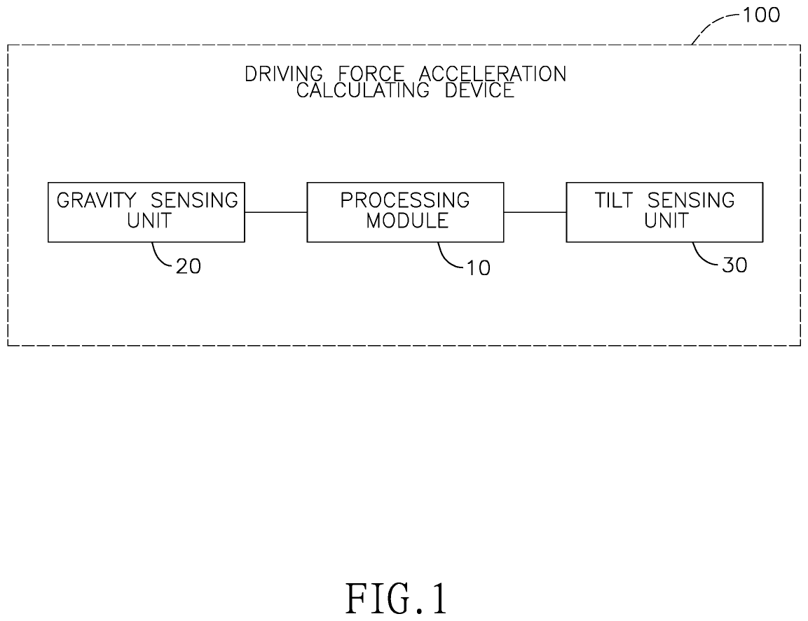

With reference to FIG. 1, the present invention provides a driving force acceleration calculation method and a device thereof. The driving force acceleration calculation method and the device thereof of the present invention can be applied to various different vehicles. Here in an embodiment of the present invention, the present invention is applied to a bike. In other embodiments of the present invention, the present invention is free to be applied to other types of vehicles.

A driving force acceleration calculation device 100 of the present invention includes a processing module 10, a gravity sensing unit 20, and a tilt sensing unit 30. The processing module 10 is respectively electrically connected to the gravity sensing unit 20 and the tilt sensing unit 30. The gravity sensing unit 20 generates a sensed angle by sensing a direction of gravitational pull, and also generates a sensed acceleration by sensing speed changes. The tilt sensing unit 30 generates a tilt sensing signal by sensing tilt. The gravity sensing unit 20 is an accelerometer, and the accelerometer is also known as a G sensor. The gravity sensing unit 20 is a microelectromechanical system (MEMS) capable of sensing speed changes over three different axes for generating the sensed acceleration.

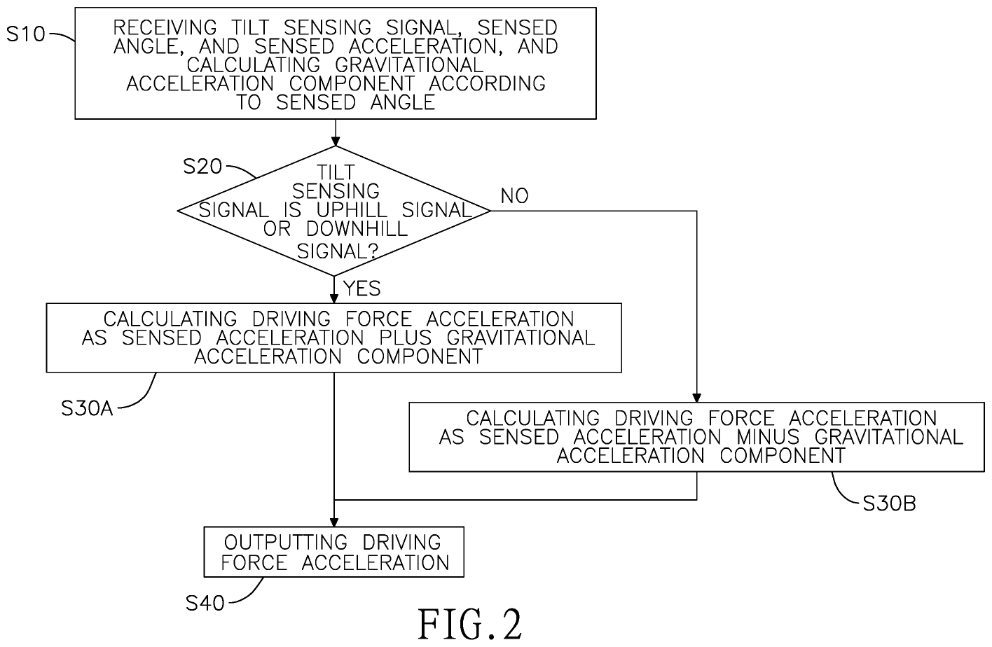

With reference to FIG. 2, a driving force acceleration calculation method of the present invention is executed by the processing module 10. The driving force acceleration calculation method includes the following steps:

Step S10: receiving a tilt sensing signal from the tilt sensing unit 30, a sensed angle and a sensed acceleration from the gravity sensing unit 20, and calculating a gravitational acceleration component according to the sensed angle;

Step S20: determining whether the tilt sensing signal is an uphill signal or a downhill signal; Step S30A: when determining that the tilt sensing signal is the uphill signal, calculating a driving force acceleration as the sensed acceleration plus the gravitational acceleration component;

Step S30B: when determining that the tilt sensing signal is the downhill signal, calculating the driving force acceleration as the sensed acceleration minus the gravitational acceleration component; and

Step S40: outputting the driving force acceleration.

If a direction parallel to a traveling direction of the bike is called a first direction, and a direction normal to the traveling direction of the bike is called a second direction, and the second direction is normal to the first direction. The gravity sensing unit 20 applied to the present invention senses gravity acting on the bike. More particularly, the gravity sensing unit 20 senses whether gravity acting on the bike is normal to the travel direction of the bike. The sensed angle the gravity sensing unit 20 senses an angle is created between a direction of gravitational pull and the second direction.

The tilt sensing signal generated by the tilt sensing unit 30 of the present invention is able to inform the bike whether the travel direction is going uphill or downhill. In the present invention, going uphill and downhill is simplified into a two dimensional problem for the bike, and therefore the gravity sensing unit 20 is able to sense two dimensional speed changes within to generate the sensed acceleration. The sensed acceleration is an acceleration measured by the gravity sensing unit 20 after the driving force acceleration of the bike is affected by the gravitational acceleration. The driving force acceleration of the bike is considered an actual acceleration of the bike without bias of the gravitational acceleration. The sensed acceleration represents an acceleration of the bike corresponding to a net force of all forces exerted on the bike. The sensed acceleration and the driving force acceleration do not necessarily equal each other. The driving force acceleration corresponds to a driving force that drives the bike.

The present invention ignores a frictional force exerted on the bike from the road. This is because the frictional force is minuscule in comparison to the driving force or the gravitational force exerted on the bike, and therefore lacks significance to be considered in physics calculations. The present invention depicts the bike traveling in ideal conditions, and therefore the present invention also ignores windage exerted on the bike.

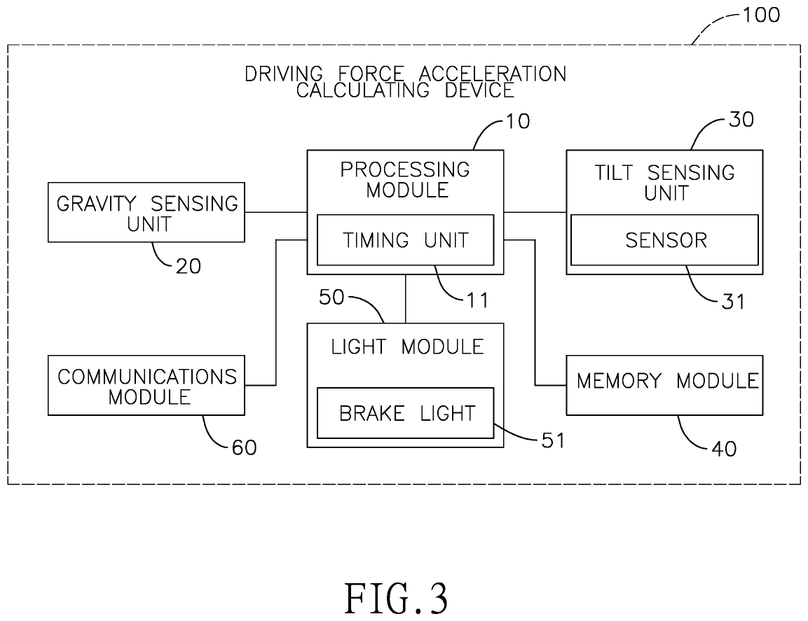

With reference to FIG. 3, in a first embodiment of the present invention, the tilt sensing unit 30 further includes a sensor 31, and a sensory ball placed on a rail. The rail is mounted along the bike, parallel to the travel direction of the tilt sensing unit 30 of the bike. The sensor 31 is mounted at an end of the rail. In the current embodiment, the sensor 31 is mounted at an end of the rail closer to a back side of the bike.

When the bike is traveling uphill, the rail tilts and causes the sensory ball to roll towards the back side of the bike because of gravity. The sensory ball rolls until the sensory ball contacts the sensor 31. Upon being contacted, the sensor 31 generates a contact signal, and as a result the tilt sensing unit 30 generates the tilt sensing signal as the uphill signal.

When the bike is traveling downhill, the rail tilts and causes the sensory ball to roll towards a front side of the bike because of gravity. The sensory ball rolls, travels away from the sensor 31, and eventually stops without contacting the sensor 31. Without any contact, the sensor 31 generates a non-contact signal, and as a result the tilt sensing unit 30 generates the tilt sensing signal as the downhill signal.

For example, when the sensor 31 generates the contact signal, the tilt sensing signal generated by the tilt sensing unit 30 is a digital signal of one. When the sensor 31 generates the non-contact signal, the tilt sensing signal generated by the tilt sensing unit 30 is a digital signal of zero. As a digital signal, the tilt sensing signal is either one or zero.

When the processing module 10 determines whether the tilt sensing signal is the uphill signal or the downhill signal, the processing module 10 basically determines whether the tilt sensing signal equals one. When the tilt sensing signal is determined to be one by the processing module 10, the tilt sensing signal is considered to be the uphill signal by the processing module 10. When the tilt sensing signal is determined to be zero by the processing module 10, the tilt sensing signal is considered to be the downhill signal by the processing module 10. In other words, the processing module 10 executes the following steps:

When determining whether the tilt sensing signal is the uphill signal or the downhill signal, determining whether the tilt sensing signal equals one;

When determining that the tilt sensing signal equals one, determining that the tilt sensing signal is the uphill signal; and

When determining that the tilt sensing signal equals zero, determining that the tilt sensing signal is the downhill signal.

In this embodiment, the driving force acceleration calculation device 100 also includes a memory module 40, a light module 50, and a communications module 60. The processing module 10 is respectively electrically connected to the memory module 40, the light module 50, and the communications module 60. The memory module 40 stores a first threshold. The light module 50 includes a brake light 51. The communications module 60 is connectable to an outside device. The processing module 10 is able to connect and output the driving force acceleration to the outside device through the communications module 60. The outside device can be a computer, a tablet computer, or a smart phone.

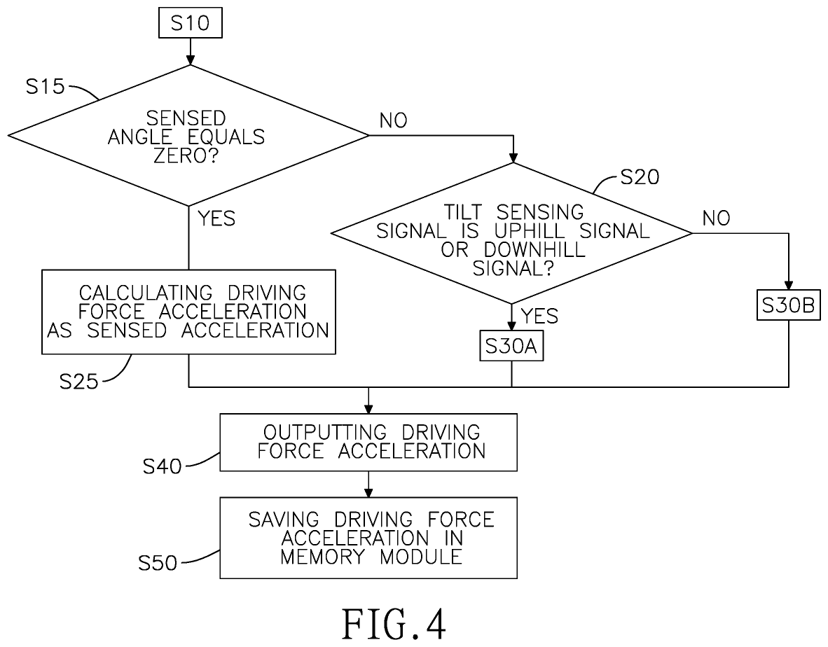

With reference to FIG. 4, in this embodiment, between step S10 and step S20, the method further includes the following steps:

Step S15: determining whether the sensed angle equals zero degree; when determining that the sensed angle is yet to be zero degree, executing step S20; and

Step S25: when determining that the sensed angle is zero degree, then calculating the driving force acceleration as the sensed acceleration, and executing step S40.

When the sensed angle is yet to be zero degree, the bike is considered to be traveling on an incline, however whether the bike is travelling uphill or downhill remains to be confirmed through executing step S20. When the sensed angle is zero degree, the bike is considered to be traveling on a plane, and therefore executing step S20 would be considered redundant. As a result, the processing module 10 directly recognizes that the driving force acceleration equals the sensed acceleration.

After the processing module 10 executes step S40, the processing module 10 further executes:

Step S50: saving the driving force acceleration in the memory module 40. This way through the communications module 60, the outside device is able to download the driving force acceleration stored inside the memory module 40.

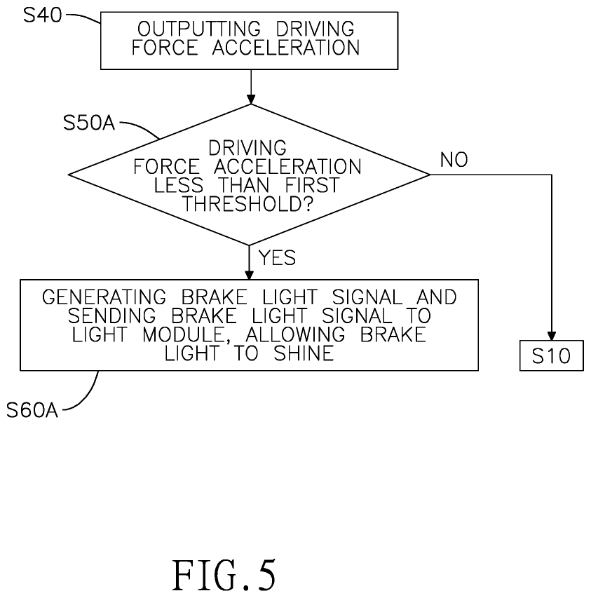

With reference to FIG. 5, in a second embodiment of the present invention, the processing module 10 further executes the following steps after executing step S40:

Step S50A: determining whether the driving force acceleration is less than the first threshold; when determining that the driving force acceleration is greater than or equal to the first threshold, executing step S10; and

Step S60A: when determining that the driving force acceleration is less than the first threshold, generating a brake light signal and sending the brake light signal to the light module 50, allowing the brake light 51 to shine.

According to physics formulations, when the driving force acceleration is negative, the bike is decelerating. When the driving force acceleration is positive, the bike is accelerating. When the driving force acceleration is zero, the bike maintains a same speed at the very moment.

In the present embodiment, the first threshold is 0 meter per second square (m/(s²)). In other words, when the bike has the driving force acceleration goes bellow 0 m/(s²), the bike is decelerating and the brake light 51 lights up. In another embodiment of the present invention, the first threshold can also be −5 m/(s²), wherein when the driving force acceleration goes bellow −5 m/(s²), the brake light 51 lights up. In this case, when the bike is decelerating but without decelerating more than −5 m/(s²), then the brake light 51 would not yet light up. This means that as long as the bike is decelerating a little without exceeding a tolerable threshold, the brake light 51 would not yet light up to warn traffic in the back of the bike.

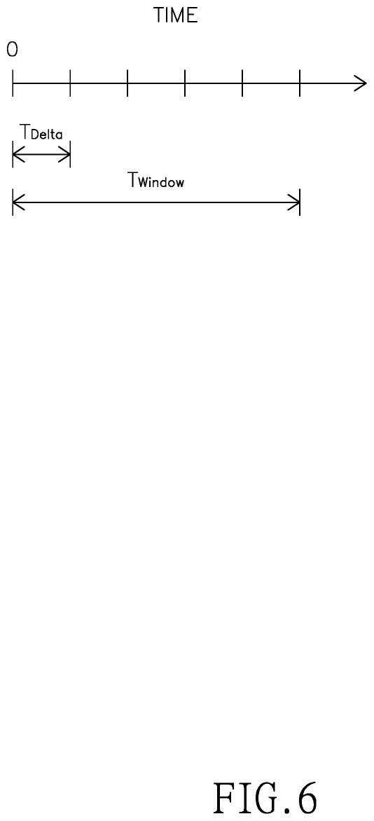

With reference to FIG. 6, in the second embodiment, the processing module 10 further includes a timing unit 11 and stores a sampling information. The sampling information includes a sampling time T_{Delta} and a sampling window time T_{Window} The sampling window time T_{Window} is a multiple of the sampling time T_{Delta}. In other words, T_{Window}=N*T_{Delta}, wherein N is a positive integer.

When the processing module 10 executes step S10, the timing unit 11 of the processing module 10 also starts counting time. After the timing unit 11 starts counting time, every time the processing module 10 determines the sampling time T_{Delta} has passed, the processing module 10 executes steps S10 through S50 and saves the driving force acceleration in the memory module 40. When the processing module 10 determines the sampling window time T_{Window} has passed, the processing module 10 executes steps S10 through S50 once again and saves the driving force acceleration in the memory module 40. In other words, the processing module 10 executes the following steps:

When executing step S10, starting counting time by the timing unit 11 of the processing module 10; and

Whenever determining that the sampling time T_{Delta} has passed, executing steps S10 through S50 and saving the driving force acceleration in the memory module 40.

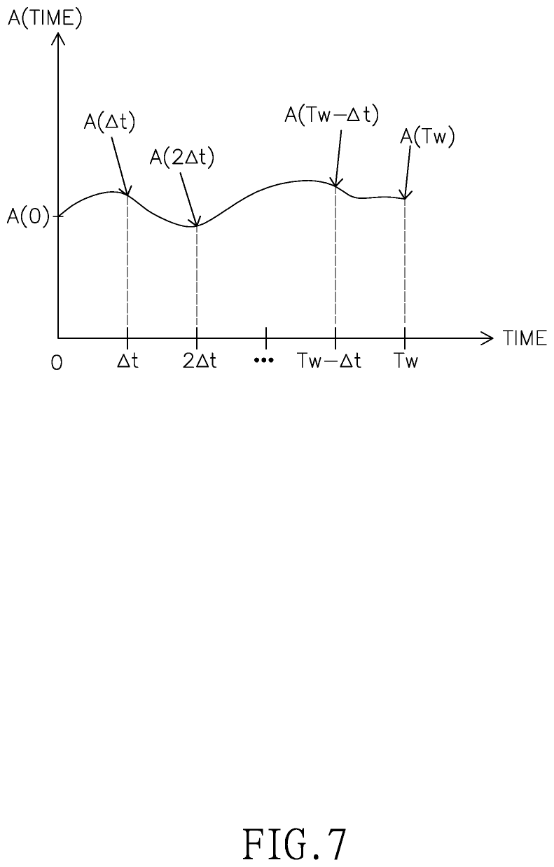

With reference to FIG. 7, the processing module 10 then further calculates a first speed change of a first period from the driving force acceleration stored inside the memory module 40. The first period starts at zero^{th} second and ends at the sampling window time T_{Window}. The first speed change is calculated using the following formula:

$$The first speed change = V ( {T}_{W} ) - V ( 0 ) \approx \frac{Δ t}{2} [ A ( 0 ) + A ( Δ t ) ] + \frac{Δ t}{2} [ A ( Δ t ) + A ( 2 Δ t ) ] + … + \frac{Δ t}{2} [ A ( {T}_{W} - Δ t ) + A ( {T}_{W} ) ] = \frac{Δ t}{2} [ A ( 0 ) + 2 * A ( Δ t ) + 2 * A ( 2 Δ t ) + … + 2 * A ( {T}_{W} - Δ t ) + A ( {T}_{W} ) ] = \frac{Δ t}{2} [ A ( 0 ) + A ( {T}_{W} ) ] + Δ t * {\sum }_{i = Δ t}^{{T}_{W} - Δ t} A ( i ) = \{ \frac{1}{2} [ A ( 0 ) + A ( {T}_{W} ) ] + {\sum }_{i = Δ t}^{{T}_{W} - Δ t} A ( i ) \} * Δ t$$

Wherein T_{W} represents the sampling window time T_{Window}, Δt represents the sampling time T_{Delta}, V(T_{W}) represents a first speed of the bike traveling at the sampling window time T_{Window}, and V(0) represents a starting speed of the bike traveling at the zero^{th} second. Wherein A(0) represents the driving force acceleration at the zero^{th} second, A(T_{W}) represents the driving force acceleration at the sampling window time T_{Window}, and Σ_{i=Δt}^{T}^{_{W}}^{-Δt} A(i) represents a summation of the driving force acceleration from the sampling time T_{Delta} to the sampling window time T_{Window} subtracted by the sampling time T_{Delta} The processing module 10 further saves the first speed change of the first period in the memory module 40.

When the first speed change is zero, the bike is considered having constant speed. This means the first speed subtracted by the starting speed equals zero, and so the first speed and the starting speed are equal. When the first speed is positive, the bike is considered accelerating, as the first speed is faster than the starting speed. When the first speed is negative, the bike is considered decelerating, as the first speed is slower than the starting speed.

Regarding the above descriptions, the processing module 10 executes the step:

When determining that the sampling window time T_{Window} has passed, executing steps S10 through S50, saving the driving force acceleration in the memory module 40, and calculating the first speed change from a zero^{th} second to the sampling window time T_{Window} from the driving force acceleration stored inside the memory module 40.

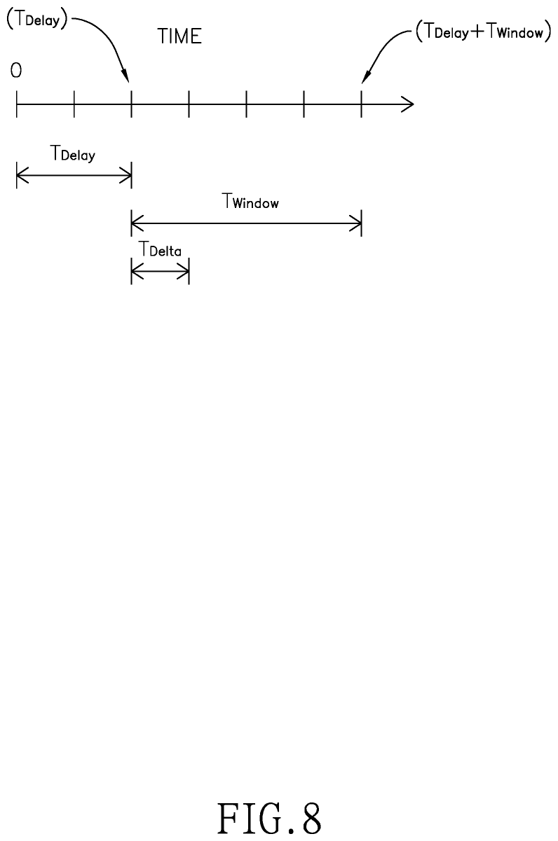

With reference to FIG. 8, in a third embodiment of the present invention, the sampling information further includes a delay time T_{Delay}. The delay time T_{Delay} is also a multiple of the sampling time T Delta. In other words, T_{Window}=K*T_{Delta}, wherein K is a positive integer smaller than or equal to N. This means the delay time T_{Delay} is also less than or equal to the sampling window time T_{Window}.

The processing module 10 further calculates a second speed change of a second period from the driving force acceleration stored inside the memory module 40. The second period starts at the delay time T_{Delay} and ends at the delay time T_{Delay} plus the sampling window time T_{Window} The processing module 10 further stores the second speed change of the second period in the memory module 40. The second speed change of the second period is calculated using the following formula:

$$V ( {T}_{D} + {T}_{W} ) - V ( {T}_{D} ) = \{ \frac{1}{2} [ A ( {T}_{D} ) + A ( {T}_{D} + {T}_{W} ) ] + {\sum }_{i = {T}_{D} + Δ t}^{{T}_{D} + {T}_{W} - Δ t} A ( i ) \} * Δ t$$

Wherein T_{D} represents the delay time T_{Delay}, Tₒₘ, represents the sampling window time T_{Window}, and Δt represents the sampling time T_{Delta}. The difference being, here a sampling window is moved by the delay time T_{Delay}, and so the starting time of the sampling window is the delay time T_{Delay}, and the ending time of the sampling window is the delay time T_{Delay} plus the sampling window time T_{Window}.

If the delay time T_{Delay} equals the sampling window time T_{Window}, then the processing module 10 starts calculating the second speed change of the second period as soon as the processing module 10 finishes calculating the first speed change of the first period. In practical terms, in this case, the processing module 10 calculates a speed change for every passing of the sampling window time T_{Window}.

Furthermore, in this embodiment, the processing module 10 further calculates a third speed change of a third period, and saves the third speed change of the third period in the memory module 40. The third period starts at double the delay time T_{Delay}, and ends at double the delay time T_{Delay} plus the sampling window time T_{Window}. The third speed change of the third period is calculated using the following formula:

$$V ( 2 {T}_{D} + {T}_{W} ) - V ( 2 {T}_{D} ) = \{ \frac{1}{2} [ A ( 2 {T}_{D} ) + A ( 2 {T}_{D} + {T}_{W} ) ] + {\sum }_{i = 2 {T}_{D} + Δ t}^{2 {T}_{D} + {T}_{W} - Δ t} A ( i ) \} * Δ t$$

Wherein 2T_{D} represents double the delay time T_{Delay}, in other words, another speed change is calculated after the delay time T_{Delay} has passed twice. The sampling window is shifted by double the delay time T_{Delay}, and so the starting time of sampling is double the delay time T_{Delay}, and the ending time of sampling is double the delay time T_{Delay} plus the sampling window time T_{Window}.

Furthermore, the processing module 10 determines whether the first speed change of the first period, the second speed change of the second period, and the third speed change of the third period stored inside the memory module 40 are all respectively greater than zero. When the first speed change of the first period, the second speed change of the second period, and the third speed change of the third period are determined to be all respectively greater than zero, the processing module 10 considers the bike is actually decelerating, rather than having misinterpretations of deceleration of the bike due to vibrations in a short time period. The processing module 10 then sends the brake light signal to the light module 50, allowing the brake light 51 to shine. When the processing module 10 determines any one of the first speed change of the first period, the second speed change of the second period, and the third speed change of the third period is less than or equal to zero, the processing module 10 then is yet to consider the bike decelerating. As a result, the processing module 10 is yet to generate and send the brake light signal to the light module 50.

Regarding the above descriptions, the processing module 10 executes the following steps:

Calculating the second speed change from the delay time T_{Delay} to the delay time T_{Delay} plus the sampling window time T_{Window} from the driving force acceleration stored inside the memory module 40;

Calculating the third speed change from double the delay time T_{Delay} to double the delay time T_{Delay} plus the sampling window time T_{Window} from the driving force acceleration stored inside the memory module 40;

When determining that the first speed change, the second speed change, and the third speed change are all respectively greater than zero, generating the brake light signal; and

When determining that any one of the first speed change, the second speed change, and the third speed change is less than or equal to zero, omitting generating the brake light signal.

In conclusion, in the aforementioned second embodiment and third embodiment of the present invention, the memory module 40 stores the driving force acceleration with changes across different times. The processing module 10 is able to access the driving force acceleration of any given time through the memory module 40, and the processing module 10 is able to conduct various integration calculations or averaging calculations with the driving force acceleration across different times. The processing module 10 can further output the averaged driving force acceleration and the moving average driving force acceleration to the outside device through the communications module 60. This way the present invention extends applications of having an accurately calculated value of the driving force acceleration available for further calculations. The present invention ensures the driving force acceleration of the bike is available for other data gathering uses extending beyond the bike.

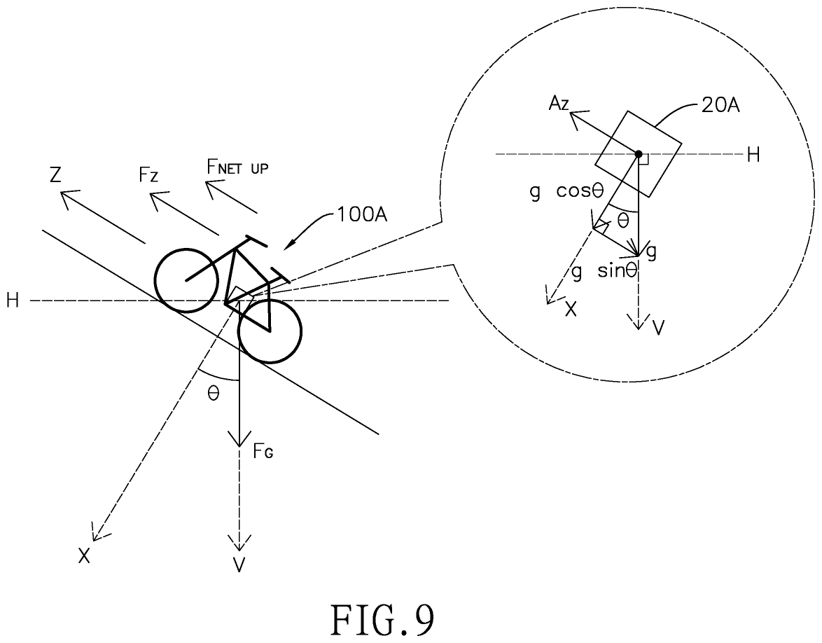

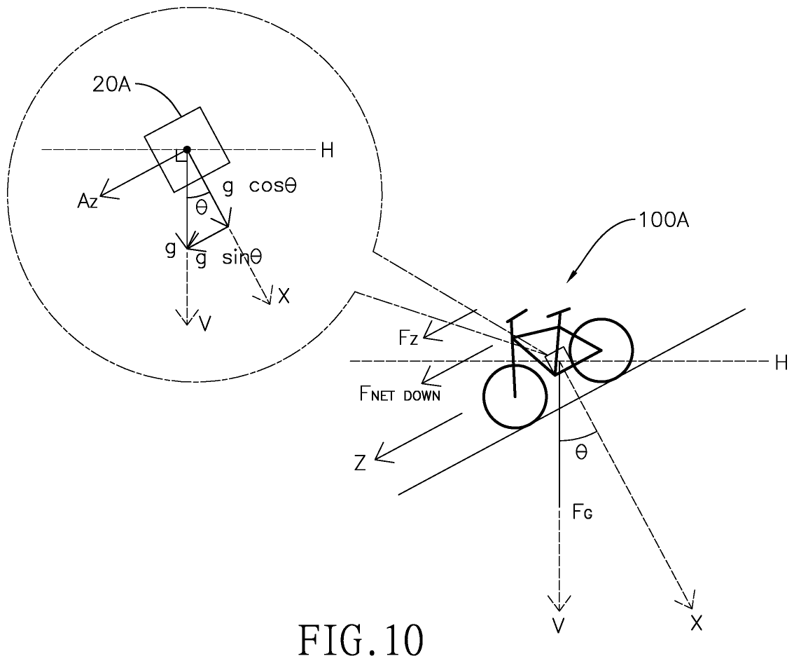

With reference to FIGS. 9 and 10, FIG. 9 represents a perspective view of the bike traveling uphill, and FIG. 10 represents a perspective view of the bike traveling downhill. Regarding paragraphs described in the prior art section, g*sin (θ) represents the gravitational acceleration component when the bike is traveling uphill or downhill, wherein g is the gravitational acceleration, and θ is the sensed angle generated by the gravity sensing unit 20.

What is claimed is:

1. A driving force acceleration calculation method, executed by a processing module; wherein the processing module is electrically connected to a gravity sensing unit and a tilt sensing unit, and the driving force acceleration calculation method comprises steps of:
step S10: receiving a tilt sensing signal from the tilt sensing unit, a sensed angle and a sensed acceleration from the gravity sensing unit, and calculating a gravitational acceleration component according to the sensed angle;
step S20: determining whether the tilt sensing signal is an uphill signal or a downhill signal;
step S30A: when determining that the tilt sensing signal is the uphill signal, calculating a driving force acceleration as the sensed acceleration plus the gravitational acceleration component;
step S30B: when determining that the tilt sensing signal is the downhill signal, calculating the driving force acceleration as the sensed acceleration minus the gravitational acceleration component;
step S40: outputting the driving force acceleration.

2. The driving force acceleration calculation method as claimed in claim 1, further comprising steps of:
when determining whether the tilt sensing signal is the uphill signal or the downhill signal, determining whether the tilt sensing signal equals one;
when determining that the tilt sensing signal equals one, determining that the tilt sensing signal is the uphill signal;
when determining that the tilt sensing signal equals zero, determining that the tilt sensing signal is the downhill signal.

3. The driving force acceleration calculation method as claimed in claim 1, further comprising the following steps:
step S50A: determining whether the driving force acceleration is less than the first threshold; when determining that the driving force acceleration is greater than or equal to the first threshold, executing step S10;
step S60A: when determining that the driving force acceleration is less than a first threshold, generating a brake light signal.

4. The driving force acceleration calculation method as claimed in claim 2, further comprising the following steps:
step S50A: determining whether the driving force acceleration is less than a first threshold; when determining that the driving force acceleration is greater than or equal to the first threshold, executing step S10;
step S60A: when determining that the driving force acceleration is less than the first threshold, generating a brake light signal.

5. The driving force acceleration calculation method as claimed in claim 1, wherein between step S10 and step S20, the method further comprises the following steps:
step S15: determining whether the sensed angle equals zero degree; when determining that the sensed angle is zero degree, executing step S20;
step S25: when determining that the sensed angle is zero degree, calculating the driving force acceleration as the sensed acceleration, and executing step S40.

6. The driving force acceleration calculation method as claimed in claim 2, wherein between step S10 and step S20, further comprising the following steps:
step S15: determining whether the sensed angle equals zero degree; when determining that the sensed angle is yet to be zero degree, executing step S20;
step S25: when determining that the sensed angle is zero degree, calculating the driving force acceleration as the sensed acceleration, and executing step S40.

7. The driving force acceleration calculation method as claimed in claim 1, further comprising the following step:
step S50: saving the driving force acceleration in a memory module.

8. The driving force acceleration calculation method as claimed in claim 7, wherein the processing module comprises a timing unit and stores a sampling information, the sampling information comprises a sampling time and a sampling window time, the sampling window time is a multiple of the sampling time, and the driving force acceleration calculation method further comprises steps of:
when executing step S10, starting counting time by the timing unit of the processing module;
whenever determining that the sampling time has passed, executing steps S10 through S50 and saving the driving force acceleration in the memory module;
when determining that the sampling window time has passed, executing steps S10 through S50, saving the driving force acceleration in the memory module, and calculating a first speed change from a zero^{th} second to the sampling window time from the driving force acceleration stored inside the memory module.

9. The driving force acceleration calculation method as claimed in claim 8, wherein the sampling information further comprises a delay time, the delay time is also a multiple of the sampling time, the delay time is less than or equal to the sampling window time, and the driving force acceleration calculation method further comprises steps of:
calculating a second speed change from the delay time to the delay time plus the sampling window time from the driving force acceleration stored inside the memory module;
calculating a third speed change from double the delay time to double the delay time plus the sampling window time from the driving force acceleration stored inside the memory module;
when determining that the first speed change, the second speed change, and the third speed change are all respectively greater than zero, generating a brake light signal;
when determining that any one of the first speed change, the second speed change, and the third speed change is less than or equal to zero, omitting generating the brake light signal.

10. A driving force acceleration calculation device, comprising:
a gravity sensing unit, generating a sensed angle by sensing a direction of gravitational pull, and generating a sensed acceleration by sensing speed changes;
a tilt sensing unit, generating a tilt sensing signal by sensing tilt;
a processing module, electrically connecting the gravity sensing unit and the tilt sensing unit, receiving the tilt sensing signal from the tilt sensing unit, the sensed angle and the sensed acceleration from the gravity sensing unit, and calculating a gravitational acceleration component according to the sensed angle;
wherein the processing module determines whether the tilt sensing signal is an uphill signal or a downhill signal; when the processing module determines the tilt sensing signal is the uphill signal, the processing module calculates a driving force acceleration as the sensed acceleration plus the gravitational acceleration component; when the processing module determines the tilt sensing signal is the downhill signal, the processing signal calculates the driving force acceleration as the sensed acceleration minus the gravitational acceleration component; the processing module further outputs the driving force acceleration.

11. The driving force acceleration calculation device as claimed in claim 10, wherein:
the tilt sensing unit comprises a sensor, and a sensory ball placed on a rail; the rail is mounted parallel to a travel direction of the tilt sensing unit, and the sensor is mounted at an end of the rail;
when traveling uphill, the rail tilts, the sensory ball rolls towards an end of the rail because of gravity, and the sensory ball contacts the sensor, causing the tilt sensing unit to generate the tilt sensing signal as the uphill signal;
when traveling downhill, the rail tilts, the sensory ball rolls towards another end of the rail because of gravity, and the sensory ball travels away from the sensor without contacting the sensor, causing the tilt sensing unit to generate the tilt sensing signal as the downhill signal.

12. The driving force acceleration calculation device as claimed in claim 11, further comprising:
a memory module, electrically connecting the processing module, storing a first threshold; wherein the processing module outputs the driving force acceleration to the memory module;
a light module, electrically connecting the processing module, comprising a brake light;
a communications module, electrically connecting the processing module; wherein the communications module is connectable to an outside device, and the processing module is able to connect and output the driving force acceleration to the outside device through the communications module;
wherein the processing module determines whether the driving force acceleration is less than the first threshold; when the driving force acceleration is determined to be greater than or equal to the first threshold, the processing module receives the tilt sensing signal from the tilt sensing unit, the sensed angle and the sensed acceleration from the gravity sensing unit, and calculates the gravitational acceleration component according to the sensed angle again; when the driving force acceleration is determined to be less than the first threshold, the processing module generates a brake light signal and sends the brake light signal to the light module, allowing the brake light to shine.
